(19) United States
(12) Patent Application Publication
(10) Pub. No.: US 2014/0063521 A1
(43) Pub. Date: Mar. 6, 2014

(54) SERVER SYSTEM OF A PRINTING SYSTEM

(71) Applicants: Toshiba Tec Kabushiki Kaisha, Tokyo (JP); Kabushiki Kaisha Toshiba, Tokyo (JP)

(72) Inventors: Masami TAKAHATA, Tokyo (JP); Mika Hirama, Tokyo (JP); Naoki Watanabe, Tokyo (JP); Tomonori Ikumi, Shizuoka (JP); Akihiko Fujiwara, Kanagawa (JP)

(73) Assignees: Toshiba Tec Kabushiki Kaisha, Tokyo (JP); Kabushiki Kaisha Toshiba, Tokyo (JP)

(21) Appl. No.: 13/957,384

(22) Filed: Aug. 1, 2013

(30) Foreign Application Priority Data
Aug. 30, 2012 (JP) 2012-190384

(51) Int. Cl. H04N 1/00

(52) U.S. Cl. CPC H04N 1/00408; H04N 1/00278
USPC 358/1.13; 358/1.15

(57) ABSTRACT

A server system of a printing system includes a storage section, a control section and an interface section. The storage section is configured to store a plurality of theme data each including screen display data and data defining the action of an object to be displayed on the screen. The control section is configured to create data for displaying according to the theme data selected from the plurality of theme data stored in the storage section, and switch the data for displaying from existing data to the created data. The interface section is configured to output the data for displaying as switched by the control section.

### CROSS-REFERENCE TO RELATED APPLICATION

This application is based upon and claims the benefit of priority from Japanese Patent Application No. 2012-190384, filed Aug. 30, 2012, the entire contents of which are incorporated herein by reference.

### FIELD

Embodiments described herein relate to a technology for switching display contents or a display object on an operation screen of a printing system.

### BACKGROUND

In a store such as a convenience store and the like, facilities of the local government such as an government office and the like, or educational facilities such as a primary school and the like, there is a terminal (hereinafter, referred to as kiosk terminal) generating a desired printout by being operated by a guest, a sales clerk or a staff member.

Besides the usual copying function or a printing function, such a kiosk terminal generates an issue list and the like, of a ticket or an electronic money when it is in a store, generates a residence permit and the like when it is in a government office, and generates a printout in a predefined registered format, such as a notification sheet and the like, when it is in an educational facility.

### BRIEF DESCRIPTION OF THE DRAWINGS

FIG. 1 is a schematic diagram illustrating an example of a printing system of one embodiment;

FIG. 2 is a diagram illustrating a functional block of an example of a server of the embodiment;

FIG. 3 is a diagram illustrating one example of a data structure of an edited object of the embodiment;

FIG. 4 is a diagram illustrating a display example of the printing system of the embodiment;

FIG. 5 is a flow chart illustrating an example of a customization setting of the printing system of the embodiment;

FIG. 6 is a flow chart illustrating an example of a theme setting of the embodiment;

FIG. 7 is a flow chart illustrating an example of when one screen of the embodiment is set;

FIG. 8 is a flow diagram illustrating an example of when the theme is changed into a theme corresponding to a season based on the printing system of the embodiment;

FIG. 9 is a flow diagram illustrating an example of when the theme is changed into a theme corresponding to a machine specification of the printing system of the embodiment;

FIG. 10 is a flow chart illustrating an example of a printing setting change when there is a change in the theme.

### DETAILED DESCRIPTION

According to one embodiment, a server system includes a storage section, a control section and an interface section. The storage section is configured to store a plurality of theme data each including screen display data and data defining the action of an object to be displayed on the screen. The control section is configured to create data for displaying according to the theme data selected from the plurality of theme data stored in the storage section, and switch the data for displaying from existing data to the created data. The interface section is configured to output the data for displaying as switched by the control section.

The background image of a screen, parts image such as a button image and the like, and other display elements such layout, design and screen transitions and the like, which are displayed by a control panel of the kiosk terminal, are created beforehand in the present embodiment. In addition, in the present embodiment, an element defining the action or a behavior when a displayed object (button and the like) is operated, is created beforehand, and such elements are combined with the display elements by establishing a correspondence between the two.

In the present embodiment, printing setting for a file, filtering setting of a file and a logo are also created beforehand, and these elements are also combined with the other elements described above by establishing a correspondence thereto. The combination of all of these elements is defined herein as a “subject”.

The theme is constructed by combining each element when the system is developed. Thus, the customization can be effectively carried out according to the purpose of a delivery target. In addition, when the system is applied, the theme reflected in the system is dynamically changed according to various kinds of information. In addition, when the system is applied, a user can freely create the theme by combining the different elements of the theme and reflect it in the system.

Hereinafter, the present embodiment is described with reference to accompanying drawings.

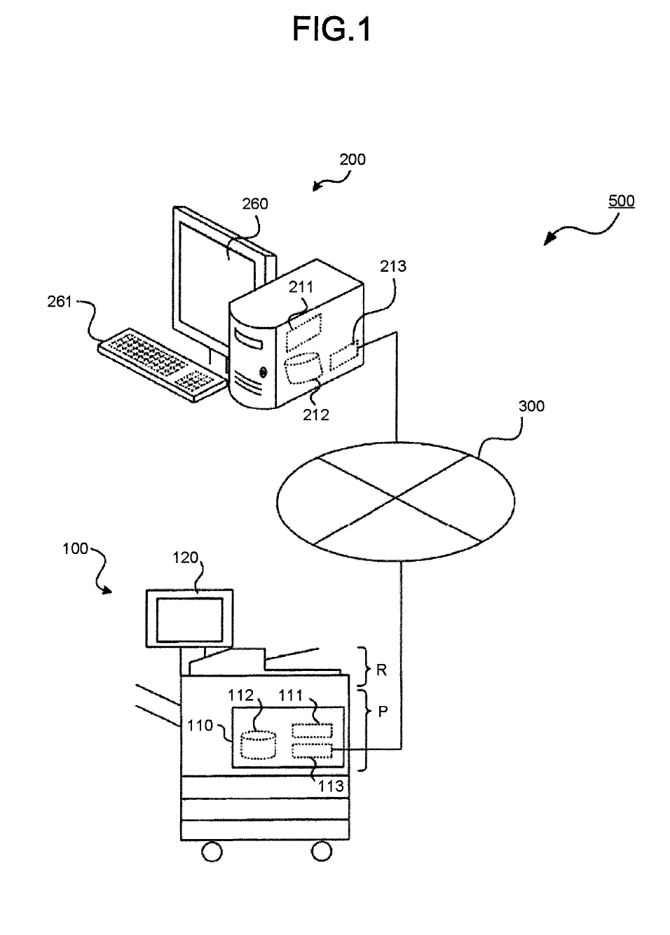

FIG. 1 is an integral structural diagram exemplifying an example system of the embodiment. A printing system 500 comprises a kiosk terminal 100 and a server 200 (server system), and they are configured to carry out communication with each other through a network 300.

The kiosk terminal 100 is an apparatus forming an image on paper according to the instruction of the user. The kiosk terminal 100 comprises a reading section R, an image forming section P, a control board 110 and a control panel 120.

The reading section R is a unit mainly used when the copying of an original is carried out, and is a unit scanning the original sheet and converting the image of a paper medium into electronic data. The reading section R includes a luminous body irradiating the original and a carriage moving the luminous body, a CCD image sensor (Charge Coupled Device Image sensor) as an image capturing device, and an optical system with a mirror and a lens guiding reflected light from the original into the CCD image sensor.

The image forming section P is a unit receiving image data and electronic image data acquired by the reading section R and forming the toner image of the image data on the sheet. The image forming section P includes a conveying path conveying the sheet to each machine, a photosensitive drum, a transferring unit transferring the image formed on the photosensitive drum on the sheet, and a fixer heating and fixing the transferred toner image on the sheet.

The control board 110 is a unit integrally controlling hardware in the kiosk terminal 100, and comprises a processor 111, a storage apparatus 112 and a communication board 113. The processor 111 is an arithmetic processing apparatus such as a CPU (Central Processing Unit) or a MPU (Micro Processing Unit) and the like, and executes a program stored in the storage apparatus 112 to carry out image processing or the control of the hardware. The storage apparatus 112 includes a volatile storage apparatus such as a RAM (Random Access Memory) and the like, a non-volatile storage apparatus such as a hard disk drive or a flash memory and the like, and stores a program and the data described later. The communication board 113 is a unit controlling the transmission and the reception of the data between it and an external machine, and for example, is an LAN (Local Area Network) card.

The control panel 120 is an apparatus displaying an operation screen for a user and accepting the input of a user. In the present embodiment, a flat-type liquid crystal displaying apparatus and an input apparatus having a touch panel form are included as the control panel 120.

The server 200 is the same as a conventional computer, and comprises a processor 211 such as a CPU and the like, a storage apparatus 212 such as a RAM or a hard disk drive and the like, and a communication board 213 such as a LAN card and the like. In addition, the server 200 comprises a display 260 as an output apparatus, a keyboard 261 or a mouse (not shown in figures) as an input apparatus.

The communication board 113 mutually carries out the transmission and the reception of the data with the communication board 213 through the network 300. In addition, in the present embodiment, in the storage apparatus 212 of the server 200, a WEB server program or a WEB browser program is read beforehand, and in the kiosk terminal 100, the WEB browser program is read beforehand. The WEB browser program transmits an HTML get request to the WEB server program, and the WEB server program replies with an HTML file or other data, so as to carry out the displaying or an operation. The WEB server program and the WEB browser program are assumed to make use of the existing program in the present embodiment.

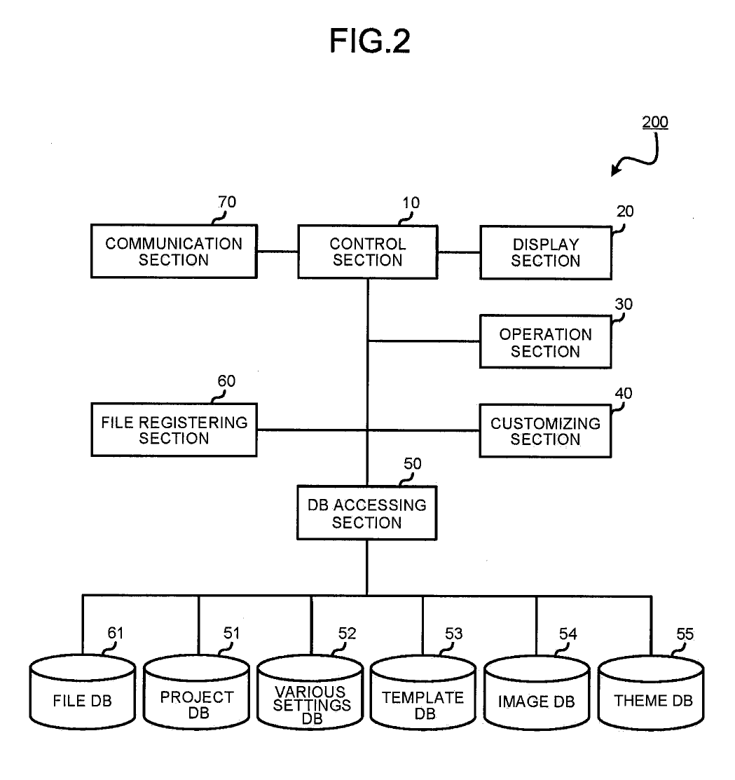

FIG. 2 is a block diagram illustrating the structure of the server 200. The server 200 comprises a control section 10, a display section 20, an operation section 30, a customizing section 40, a DB (Database) accessing section 50, a file registering section 60 and a communication section 70. These sections are realized by loading the program stored in the storage apparatus 212 and executing the program by the processor 211 of the server 200.

The control section 10 controls the execution of each block illustrated in FIG. 2. The display section 20 includes the display 260 or a video driver (not shown in the figures), and displays a processed content or an execution result for the user or an operator through the display 260, and in addition, displays the operation screen which is the same as that shown on the control panel 120 of the kiosk terminal 100 through the WEB browser program.

The operation section 30 includes a keyboard 261 or a mouse, and accepts an input from a user or an operator. The customizing section 40 controls the setting of the theme or the editing processing of a template, which includes image data such as a background image for displaying and button image. The displaying position, size and quantity, and the program executed in response to the operation of the user are combined and prepared beforehand. In the present embodiment, a plurality of templates are prepared beforehand, and are stored in the storage apparatus 212.

The DB accessing section 50 is a section for carrying out access control to a database (DB), and mainly performs the registration, the cancellation, the update and the retrieval of the data in the DB. The file registering section 60 registers a printed document data or a formatted data through the DB accessing section 50. The printed document data or the formatted data are document data created by other computer or original data and the like read by the reading section R of the kiosk terminal 100. The communication section 70 includes a communication board 213, and executes data communication with the kiosk terminal 100.

In addition, in the storage apparatus 212 of the server 200, a plurality of DBs including a file DB 61, a project DB 51, a various settings DE 52, a template DB 53, an image DB 54 and a theme DB 55 are stored with a DB unit or a table unit, and are accessed and controlled by the DB accessing section 50.

The file DB 61 is a DB storing the printed document data or the formatted data registered by the file registering section 60, and establishes the correspondence to the entity data of the document, a document ID (Identification) uniquely defining the document and the attribute information of the document to store them. The attribute information is a category which can be randomly designated by the user according to the purpose and information for grouping the printed document and the like, for example, “Resident card”, “Census register”, “Commodity below 1000 yen”, “Commodity from 1000 yen to 2000 yen” and the like. When the printed document data or the formatted data are not stored in a DB but in a file form in the file DB 61, a file name or a path name as its link data is stored.

The project DB 51 is used when the theme is constructed, and establishes its correspondence with a project ID, a project name or each file name of an image file or a layout file and a control code file used in a project. The construction or the customization of the theme in the present embodiment are carried out in this method by first creating a project and then editing the data in the project and the like by using the project as a unit. The project DB 51 is a DB managing (creating, updating, canceling, retrieving, etc.) the project.

The various settings DB 52 establishes the correspondence to the printing setting (duplex/simplex printing setting, color/grey scale printing setting, allocation printing setting, sheet size and the like) or logo data for printing, character string data printed as a watermark and the information of a printing position, and are stored together with a uniquely defining ID. In addition, in the various settings DB 52, a filtering rule or the function setting is also stored by establishing the correspondence with the same ID.

The template DB 53 stores a template ID enabling template data to be unique and a JavaScript° executed at a browser side or the entity data (or the file name or the path name of these entity data) of a CSS (Cascading Style Sheets) as a style sheet displaying the layout by establishing the correspondence with each other. A plurality of the combinations of the displaying position of the parts image such as the button image and the like, and its quantity or a processing action caused by a user's operation such as pressing down the button and the like are prepared as the template beforehand in the present embodiment, and are registered in the template DB 53. A necessary position is corrected for the template data when a user carries out the customization. In addition, in the present embodiment, one screen image is assumed to be formed according to one template datum.

The image DB 54 stores an image ID enabling the image to be unique and the entity data (or the information determining the image file, for example, the filename, the path name, etc.) thereof correspondingly. The image data includes the background image or the parts image such as the button image, a logo image, etc.

The theme DB 55 is a DB establishing the correspondence to each ID held by the DBs 51-54 and 61 mentioned above and combining and holding it together with a theme ID uniquely defining the theme. In addition, the theme along with the transition to a plurality of screens such as a standby screen, a category selection screen, a printout selection screen and the like is configured by establishing the correspondence to a plurality of template IDs, the image ID and a various settings ID for one theme ID.

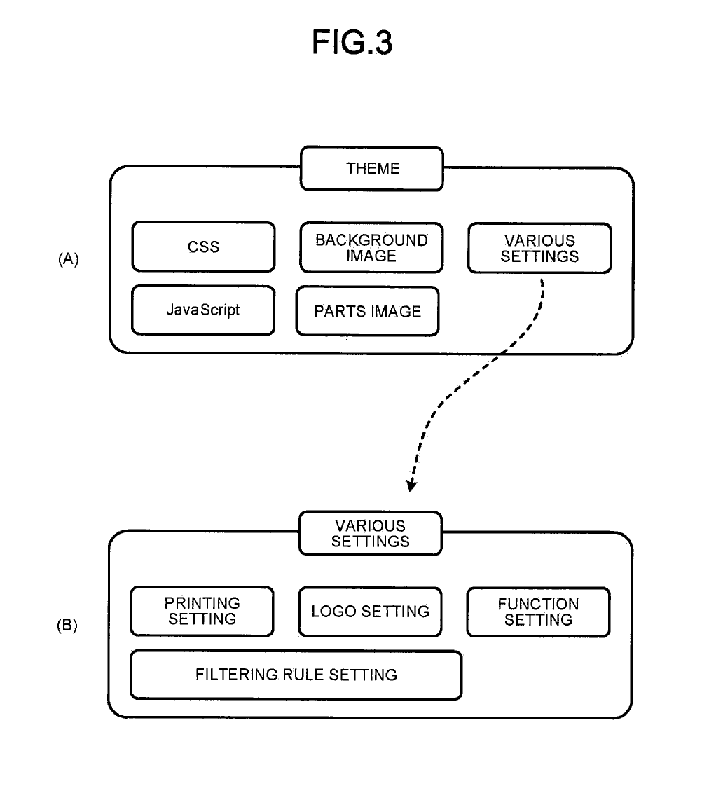

FIG. 3(A) is a diagram illustrating the data bound as the theme by the correspondence establishment saved in the theme DB 55. The theme in the present embodiment including the CSS, the JavaScript, the background image, the parts image and the various settings, and the combination of these data is used as the theme. In addition, FIG. 3(B) is a diagram exemplifying the various settings. The various settings are formed by the printing setting, the logo setting for printing, the function setting and the filtering rule setting as the data stored in correspondence with the various settings DB 52 mentioned above, and are defined by the combination of these data.

In the present embodiment, the data in the HTML form are analyzed by the WEB browser program of the kiosk terminal 100 or the server 200, and are displayed on the control panel 120 or the display 260. The server 200 uses the WEB server program to transmit the data in the HTML form corresponding to a requirement from the browser, and meanwhile, also transmits a JavaScript file and a CSS file reflected in the system as a theme for reading. In the data in the HTML form, there is a narration designating the JavaScript file and the CSS file, the JavaScript is executed according to the narration, and a style defined in the CSS file is displayed.

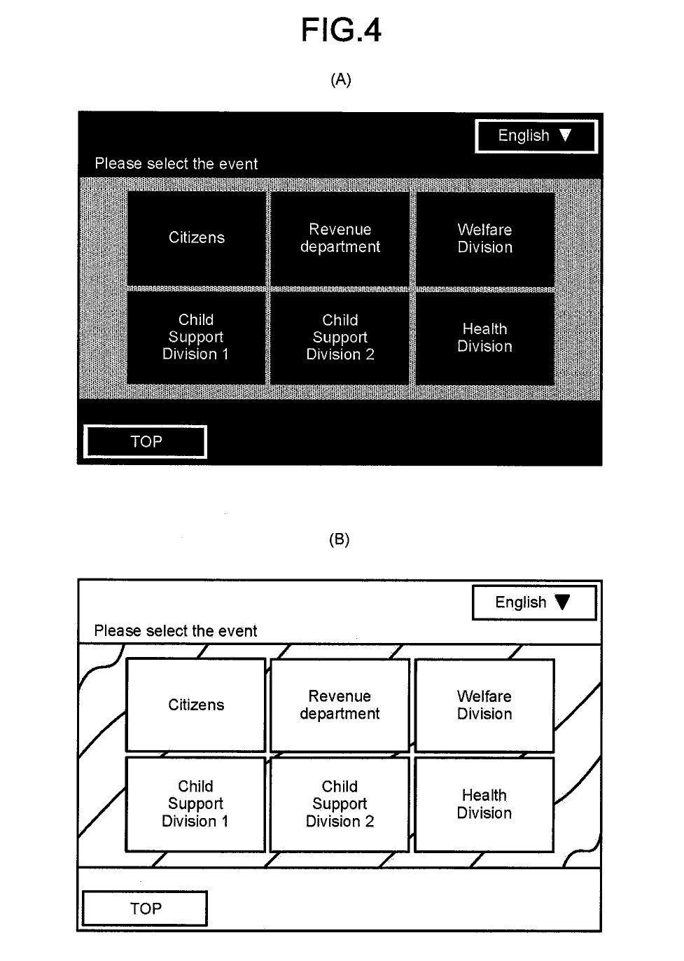

Herein, FIG. 4 illustrates an example of the displaying. FIG. 4(A) is a display example illustrating the screen consisting of a background and buttons with a black keynote, and FIG. 4(B) is a display example consisting of the background and buttons with a gradation keynote. The configuration of the object such as the button and the like or the action (the action caused by the operation of the user) of the object is the same. In the present embodiment, the display is switched into FIG. 4(A) or FIG. 4(B) and the like according to the designation of the user or some other conditions.

Herein, one example of the action of a button object is described with reference to FIG. 4. If each button (rectangular area with a label such as “Citizens”, “Revenue department”, etc.) in FIG. 4(A) (FIG. 4(B) is the same) is pressed, the data corresponding to the button and requiring the page of a link target is transmitted to the server 200 together with the attribute information (for example, the “Citizens”) defined in the button. The DB accessing section 50 of the server 200 retrieves the printed document data whose attribute information is “Citizens” in the file DB 61, and outputs a result to the control section 10. The control section 10 generates a summary of the printed document data as a retrieval result. The communication section 70 replies with the HTML, the JavaScript and the CSS reflected in the system as the theme to a transmission source together with the generated summary according to the control of the control section 10. Thus, on the WEB browser, a document summary is displayed with a display form reflected in the system as the theme. Afterwards, the document is printed according to the printing setting corresponding to the theme by selecting the document expected by the user from the summary. In the present embodiment, the printing is carried out in this way according to the displaying corresponding to the theme or the printing setting corresponding to the theme.

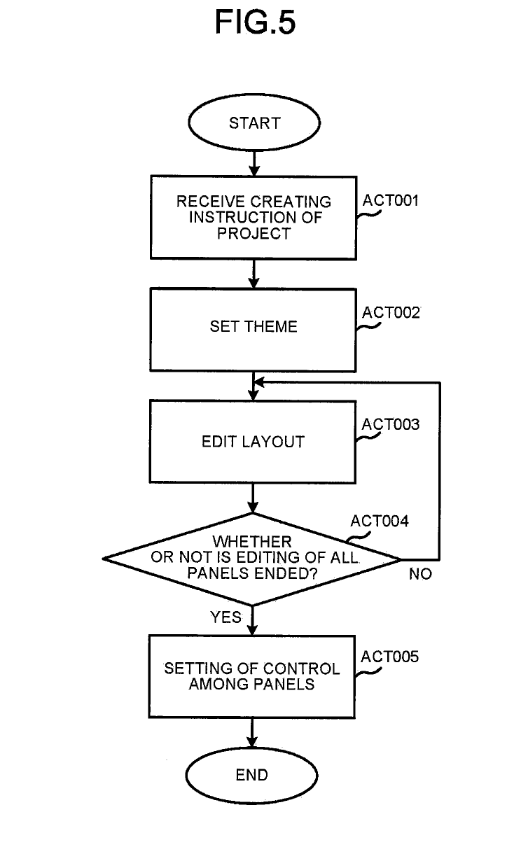

Next, an operation example of the printing system 500 is described with reference to a flow chart. FIG. 5 is a flowchart illustrating integral actions when the theme is set and the theme is subjected to the customizing. First, the control section 10 in the server 200 receives the creation instruction of the project through the operation section 30 by a specified operation of the user (herein, theme setter or constructor) (ACT001). The control section 10 acquires the project name from the user, generates the project ID and registers it in the project DB 51 together with the project name. In addition, the control section 10 generates a working folder in the storage apparatus 212 to which the project name is added. Next, the setting processing of the theme is carried out (ACT002).

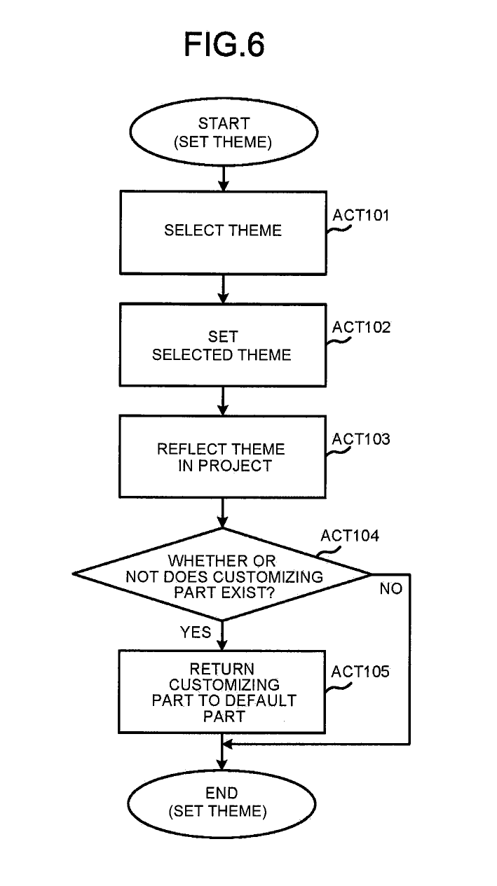

The setting processing of the theme is described with reference to FIG. 6. The display section 20 displays a summary of each of a plurality of themes registered in the theme DB 55 and prompts the user to select the theme (ACT101). The control section 10 herein acquires all the theme ID registered in the theme DB 55, and carries out the summary display in a selectable form (for example, a pull-down menu or radio button form) on the display section 20. At this time, the summary image of each displaying screen can be also displayed based on the template ID and the image ID associated with the theme ID.

The customizing section 40 reflects the theme on the project selected by the user (ACT102, ACT103). Herein, in the working folder of the project created in ACT001, the template file of the JavaScript, the template file of the CSS, the image file and the like, which are derived from the theme ID according to the correspondence relation of each DB, are stored according to a specified folder structure or a naming rule. In addition, at the moment, an HTML file as the caller of the JavaScript file, the CSS file or the image file is also generated, and is stored in the working folder.

When there is no customizing part in the theme, the setting processing of the theme is ended (No in ACT104), but if a customizing part exists in the theme, when the setting is carried out, the customizing part will return to a default state (which is the initial state of the customizing part) (ACT104, Yes, ACT105).

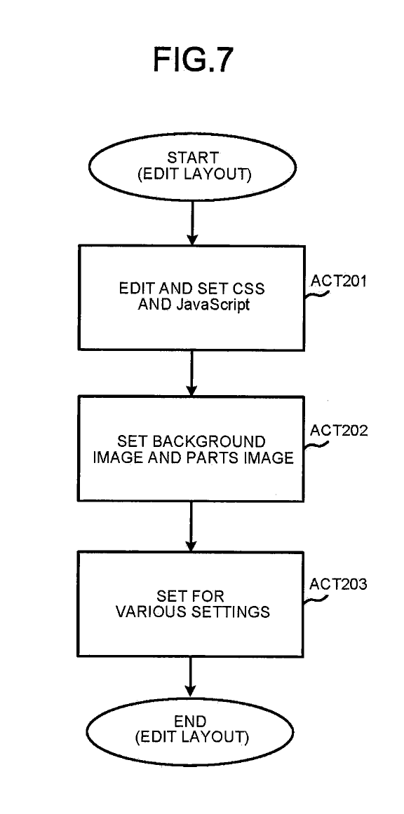

Returning to the description of FIG. 5, after the theme setting is carried out in ACT002, the customizing section 40 carries out the editing processing on the data in the working folder according to the instruction from the user (ACT003). The actions of the editing processing are described with reference to FIG. 7.

The customizing section 40 carries out the editing and the setting of the JavaScript file and the CSS file in the working folder (ACT201). In the layout of the present embodiment, an area at the upper portion of the panel is used as a header area, an area at the lower portion of the panel is used as a footer area and a central portion is used as a body area. In ACT201, the configured displayed string or its font and font size are set according to each area, and in addition, the shape, the quantity, the label and the attribute information (the label and the attribute information can be also the same value) of the object such as the button or the pull-down menu and the like and an action code when the object is operated are set. The action code is designated according to the file name of the JavaScript file. In addition, if it is the file name during theme setting, it can be also originally used.

Next, the background image and the parts image are set (ACT202). If each image can be the image selected during the previous theme setting, it is used originally, but if the image is intended to be changed, the image registered in the image DB 54 is displayed on the displaying section 20 in a summary type by the specified operation of the user to select the image expected by the user. The selected image is stored in the working folder of the project. When the image is replaced, the image is covered and stored in the existing image file in the working folder.

Next, the setting processing for other various settings is carried out (ACT203). The customizing section 40 acquires the various settings ID defined in the theme, and acquires its setting value (herein, the setting value about the displaying) with reference to the various settings DB 51. The acquired value is displayed on the display section 20. The user changes the value for a part needing to be changed and inputs it into the project.

By such an operation, the setting for the theme in the project is carried out and one panel (displaying screen) is formed. The actions (loop based on No of ACT004 in FIG. 5) in ACT201-ACT203 are executed until the editing of all the panels is ended.

When the editing of all the panels is ended (ACT004, Yes), the customizing section 40 carries out the setting of the control among the panels according to the instruction of the user (ACT005). Herein, the setting of transiting to any panel if one button in the panel is pressed down, and the like, is carried out. The rule of the transition herein can be defined in the HTML file, and can be also defined in the JavaScript file. The customizing section 40 defines the screen transition by rewriting the HTML file and/or the JavaScript file.

When the theme is created in this way, the control section 10 acquires the instruction from the user, and configures the HTML file, the JavaScript file, the CSS file or the image data in the folder which can be accessed to the WEB browser or its subfolder. Thus, if a request is received from the kiosk terminal 10, the user can carry out the displaying corresponding to the set theme. By such a processing, the existing theme for displaying can be changed into the newly created theme. In addition, the folder (the folder name is set as the theme ID in the present example) different from the folder which can be accessed to the WEB browser mentioned above can be created, and in the folder, the created HTML file, the JavaScript file, the CSS file or the image data can be also configured. It is an effective way to switch the theme in the prepared plurality of themes as needed.

The data which can be read from the WEB browser in the data prepared as a homepage is called the read data. Namely, the so-called read data refers to one of the data transmitted to the WEB browser as required by a WEB server application. In addition, it is the folder different from the folder prepared as the homepage, but the data formed by the data or the structure which can be read from the WEB browser are also called the read data.

In addition, in the present embodiment, in addition to the user switching an changing the designated theme, the change can be also carried out, so as to become the theme corresponding to a season or the theme corresponding to the specification of an apparatus in which the WEB browser program is read, and the switching the displaying or the printing setting can be carried out.

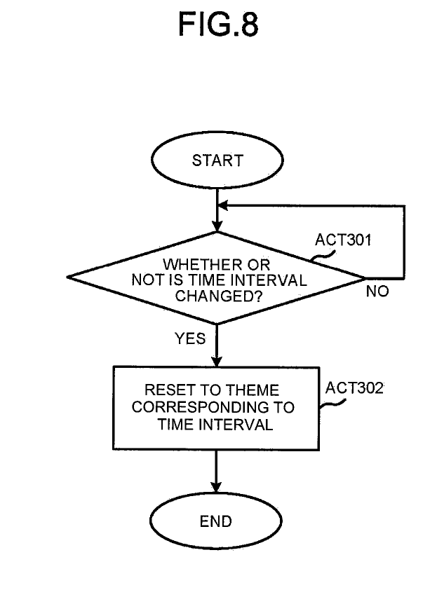

Herein, the process of switching the theme corresponding to the season is described with reference to FIG. 8.

In the present example, the plurality of themes have already been set according to the methods described in FIGS. 5-7, and in addition, it is assumed that the file or the folder (namely, the read data) in the form which can be provided by the WEB application has been already formed according to each theme respectively corresponding to seasons of spring, summer, autumn and winter, and has been prepared beforehand.

The control section 10 carries out the determination processing as to whether or not the season is changed (ACT301). The control section 10, for example, periodically acquires the information of a current date and the information of a current time (it can be also the information of the current date only) from a hardware clock per minute, and acquires month information which month it is now according to the date information. The control section 10 switches and changes the theme according to the month information (ACT302).

For example, if March-May are set as spring, June-August are set as summer, September-November are set as autumn and December-February are set as winter, when the acquired month information is switched into March from February, the control section 10 carries out the theme switching from the theme of winter to the theme of spring. The switching of other seasons is also the same. The switching herein can be also a method carrying out the switching by covering the file (the read data for the theme of winter) in the folder which can be accessed from the WEB browser or the subfolder at the read data prepared as the theme of spring, or it can be also the method switching and changing a home directory which can be accessed from a home directory of the read data of the theme of winter to the home directory of the read data of the theme of spring by renaming the home directory. In addition, in the present example, the data establishing the correspondence for each season and the theme ID are stored in the storage apparatus 212, and the control section 211 acquires the switched theme ID with reference to the correspondence data during the switching. Afterwards, the control section 211 carries out the control, so that determining the folder that the folder name becomes the theme ID and switching the data in the folder.

In the example mentioned above, an example of switching the theme according to the season is described, but the theme can be also switched in a time period such as in the morning, in the daytime, in the night and the like. The information of the current moment can be also acquired only, and the determination as to whether or not the switching is carried out is carried out by determining whether or not the acquired value of the current time reaches a specified time. In addition, the theme switching corresponding to the date can be also carried out. For example, when the kiosk is a store equipment, for a guest operating the kiosk terminal 100, for example, advertisement data such as “today is a point return day” and the like can be notified.

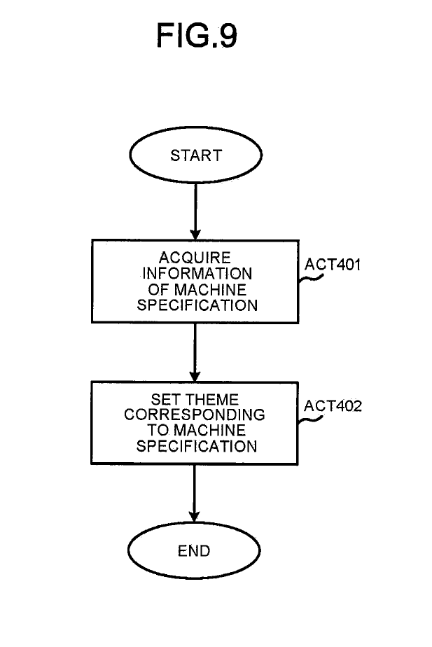

Next, the process of switching the theme according to a machine specification is described with reference to FIG. 9. In the control panel 120 of the kiosk terminal 100, there are a control panel with a low resolution and a control panel with a high resolution. In the present embodiment, switching is carried out such that the summary image is used when the resolution is low and a high-density image is used when the resolution is high. In addition, the JavaScript with a high-end function can overload, and therefore, when the processing capacity of the processor 111 of the kiosk terminal 100 is low, it can be switched into the theme executing the JavaScript restraining the function to be lower. The present example also similarly creates and prepares the read data for the high-end function and for a low-end function beforehand.

The control section 401 acquires the information of the machine specification of the kiosk terminal 100 (ACT401). The machine specification of the kiosk terminal 100 is the information which is known before the application, and therefore, it can be also the example that the information of the machine specification is pre-stored in the storage apparatus 212 of the server 200 beforehand and acquired. In addition, it can be also the example that the machine specification is acquired by a mechanism when the mechanism for acquiring the machine specification of the machine is arranged on the kiosk terminal 100. The control section 10 switches and changes the theme to correspond to the acquired information of the machine specification (ACT402). A switching method is the same as an example switching the theme according to the season mentioned above.

The method that the side of the system in the example mentioned above carries out the automatic switching according to a specified condition is a method beforehand constructing a plurality of file structures and folder structures (read data) which can be provided for the WEB browser in real time according to the flow charts in FIGS. 5-7 and switching the file or the folder structure. As another example, it can be also such an example that each theme respectively corresponding to the specified condition is prepared beforehand in the theme DB 55, and every time the specified condition is satisfied, the control section 10 acquires the theme corresponding to the condition from the theme DB 55 and constructs the file structure and the folder structure (read data) which can be provided for the WEB browser.

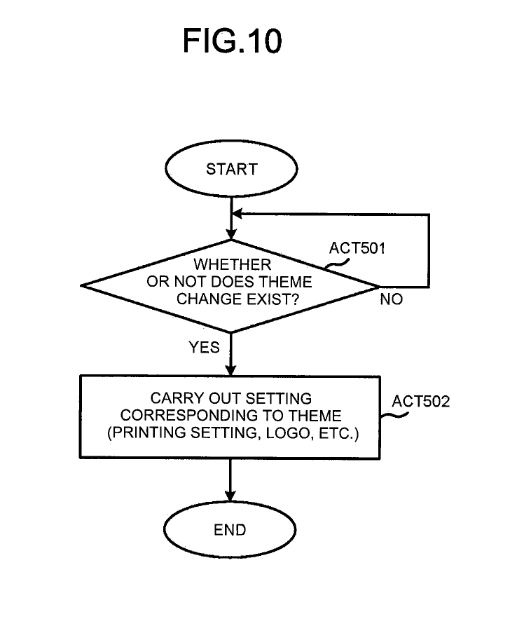

In the present embodiment, the printing setting can be also changed consistent with the change of the theme. When the change or the switching of the theme occurs, the change value of the printing setting is transmitted from the server 200 to the kiosk terminal 100. An action flow of this example is illustrated in FIG. 10. When the theme is changed (ACT501, Yes), the control section 10 of the server 200 acquires the ID of the changed theme, and acquires the various settings ID associated with the theme ID from the theme DB 55. The control section 10 acquires a printing setting value corresponding to the acquired various settings ID from the various settings DB 52 and transmits the printing setting value to the kiosk terminal 100.

The processor 111 of the kiosk terminal 100 starts a printing setting changing program pre-stored in the storage apparatus 112 by using the transmission as a trigger. The processor 111 rewrites printing setting information inside, by executing the started program, so that the transmitted printing setting value becomes the default printing setting (ACT502). Thus, the printing is carried out with a rewritten default value. By changing the theme in this way, thus, for example, the printing setting of the file can be changed from “A4 simplex printing” to “A4 duplex printing”.

In addition, in the present embodiment, the string or the logo needed for the printing can be switched according to a utilization scene. For example, when it is a store, the logo of the store can be changed, and when it is a local government facility, the logo of a city or a ward can be changed to carry out the printing.

When the string randomly designated by the user during the printing, such as “COPY” or “FORBID COPY” and the like, can be automatically added as the watermark to be printed or when the image file which can be overlaid can be designated during the printing, the kiosk terminal 100 can change the string of the watermark or the overlaid image data according to the theme by registering the string or a logo image file the same as the printing setting value in the various settings DB 52. When the change of the theme exists, the control section 10 of the server 200 also transmits the string or the logo image to the kiosk terminal 100 together with the printing setting value. The processor 111 of the kiosk terminal 100 carries out the setting, so as to use the printing setting changing program, and set the transmitted string as the watermark, and process the transmitted logo image as a image file for overlaying. Thus, the watermark or the logo image corresponding to the theme can be also printed.

In addition, when the filtering rule can be set for the kiosk terminal 100, whether or not the printing can be carried out can be determined according to the setting of the filtering rule. For example, when a character such as “Top-secret” and the like is included in the printed document, an action that the printed document is not allowed to be printed, and the like, can be carried out according to the theme. The setting of the filtering rule is also registered in the various settings DB 52 the same as the printing setting value, is transmitted to the kiosk terminal 100 the same as the printing setting value when the theme is changed, and is reflected, so that the filtering setting corresponding to the theme can be carried out.

The theme change processing mentioned above can be also carried out during an application other than system development. In addition, the user can also carry out the customizing on the theme during the application, and can reflect the customized theme in the application to utilize it. In addition, in the present embodiment, other than an appearance such as the design and the like, the setting, the addition, the action, the function or a user interface can be also added and changed according to the change of the theme.

In addition, in the present embodiment, the theme can be dynamically switched into the optimal theme and reflected based on various kinds of information. In the present embodiment, the example of changing the theme corresponding to the time/date/season and corresponding to the used machine specification are described.

In addition, according to the present embodiment, the function setting can be changed by the setting of the theme. For example, the existence/non-existence of the printing setting can be designated or the setting of the transition, such as a list view or a thumbnail view and the like can be designated by differing the function of the template or the part. In addition, the filtering rule of the file printed can be changed according to the theme and the file which can be printed can be changed according to the theme.

In the present embodiment, the printing system consisting of two casings of the server 200 and the kiosk terminal 100 is described, but the embodiment is not limited to this case. Namely, the function of the server 200 can be also taken in the kiosk terminal 100 to provide the printing system by one casing, and vice versa. It can be a structure with a plurality of kiosk terminals 100, and can be also that the functions realized by the server 200 are divided into a plurality of housings. In the present embodiment, the example is that the construction or the customizing of the theme and the provision of the read data generated according to the theme are carried out by one housing of the server 200, and they can be also used as a server system and as other housing. At this time, a detachable computer is prepared as an environment carrying out the construction or the customizing of the theme, and on which the construction of the theme to the generation of the read data are carried out. The server 200 only configures the generated read data and carries out the provision or the switching processing of WEB read data.

In addition, in the present embodiment, the embodiment generating the read data with the file structure consistent with the specification of a WEB server application as the existing WEB server application is adopted is described, but the embodiment is not limited to this case. The control section 10, for example, can be also such an example creating the read data in a data format in a transmission form (HTTP (Hyper Text Transfer Protocol) form), and other various embodiments can be also considered. In addition, the embodiment of the data transmission and reception or a reading screen in a WEB base is described, but the embodiment is not limited to this case. For example, the application in a special specification can be constructed, the read data are created in the proprietary form, and it can be also the example carrying out the transmission and the reception of the data based on the special specification and the reading of the screen.

In the present embodiment, the situation that the function implementing the embodiment is prerecorded inside the apparatus is described, but it is not limited to this, the same function can be downloaded into the apparatus from the network, and a function storing the same function in a recording medium can be also installed in the apparatus. As the recording medium, if the recording medium can store the program such as a CD-ROM and the like, and furthermore, is apparatus-readable, its form is not limited. In addition, the function acquired by pre-embodiment or downloading in this way can be also the function realized by synergistically acting with an OS (operating system) and the like inside the apparatus.

As described above in detail, according to a technology described herein, it can be switched and changed into the screen corresponding to the theme, and the useful user interface or the action can be provided.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the embodiment.

What is claimed is:

1. A server system, comprising:
a storage section configured to store a plurality of theme data each including screen display data and data defining the action of an object to be displayed on the screen;
a control section configured to create data for displaying according to the theme data selected from the plurality of theme data stored in the storage section, and switch the data for displaying from existing data to the created data; and
an interface section configured to output the data for displaying as switched by the control section.

2. The server system according to claim 1, wherein
the theme data stored in the storage section is mapped to printing setting data;
the control section includes the printing setting data in the created data; and
the interface section outputs the printing setting data for an image forming apparatus.

3. The server system according to claim 1, further comprising:
a customizing section configured to change one or more portions of the theme data according to an instruction of a user, wherein
the control section is configured to create the data for displaying according to the theme data as changed by the customizing section.

4. The server system according to claim 1, further comprising:
a customizing section configured to change one or more portions of the theme data according to an external condition, wherein
the control section is configured to create the data for displaying according to the theme data as changed by the customizing section.

5. The server system according to claim 4, wherein the customizing section is configured to change one or more portions of the theme data according to a current time, data, or season.

6. The server system according to claim 4, wherein the customizing section is configured to change one or more portions of the theme data according to a specification of an image forming apparatus.

7. The server system according to claim 1, further comprising a plurality of databases in which different portions of each theme data are stored.

8. The server system according to claim 7, wherein the databases include a display template database, an image database, and print settings database.

9. A method of generating screen display data of an operation panel of an image forming apparatus, comprising:
storing a plurality of theme data each including screen display data and data defining the action of an object to be displayed on the screen;
creating data for displaying according to the theme data selected from the plurality of theme data stored in the storage section;
switching the data for displaying from existing data to the created data; and
after said switching, transmitting the data for displaying to the image forming apparatus.

10. The method according to claim 9, wherein
the stored theme data is mapped to printing setting data;
the data for displaying that is created includes the printing setting data; and
the data for displaying that is transmitted to the image forming apparatus includes the printing setting data.

11. The method according to claim 9, further comprising:
customizing one or more portions of the theme data according to an instruction of a user, wherein the data for displaying is created according to the theme data as customized.

12. The method according to claim 9, further comprising:
customizing one or more portions of the theme data according to an external condition, wherein the data for displaying is created according to the theme data as customized.

13. The method according to claim 12, wherein the external condition is a current time, data, or season.

14. The method according to claim 12, wherein the external condition is a specification of the image forming apparatus.

15. The method according to claim 9, wherein different portions of each theme data are stored across a plurality of databases.

16. The method according to claim 15, wherein the databases include a display template database, an image database, and print settings database.

17. A printing system, comprising:
an image forming apparatus; and
a server including a storage section configured to store a plurality of theme data each including screen display data and data defining the action of an object to be displayed on the screen, a control section configured to create data for displaying according to the theme data selected from the plurality of theme data stored in the storage section and switch the data for displaying from existing data to the created data, and an interface section configured to output the data for displaying as switched by the control section to the image forming apparatus.
wherein the image forming apparatus generates an operation display based on the data for displaying.

18. The printing system according to claim 17, wherein the theme data stored in the storage section is mapped to printing setting data;
the control section includes the printing setting data in the created data; and
the interface section outputs the printing setting data for the image forming apparatus.

19. The printing system according to claim 17, wherein the server further comprises:
a customizing section configured to change one or more portions of the theme data according to a user condition or an external condition, wherein
the control section is configured to create the data for displaying according to the theme data as changed by the customizing section.

20. The printing system according to claim 17, wherein the server further comprises a plurality of databases in which different portions of each theme data are stored, the databases including a display template database, an image database, and print settings database.
